(19) United States
(12) Patent Application Publication
(10) Pub. No.: US 2026/0155114 A1
(43) Pub. Date: Jun. 4, 2026

(54) SCREEN BRIGHTNESS ADJUSTMENT METHOD AND DEVICE

(71) Applicant: Wistron Corp., New Taipei City (TW)

(72) Inventor: Chia Ling HSU, New Taipei City (TW)

(21) Appl. No.: 19/009,058

(22) Filed: Jan. 3, 2025

(30) Foreign Application Priority Data
Nov. 29, 2024 (TW) 113146253

(51) Int. Cl. G09G 5/10; G06T 7/73

(52) U.S. Cl. CPC G09G 5/10; G06T 7/73; G06T 2207/30201; G09G 2320/0626; G09G 2354/00; G09G 2360/144

(57) ABSTRACT

A screen brightness adjustment method is provided in the invention. The screen brightness adjustment method may be applied to a screen brightness adjustment device. The screen brightness adjustment method may include the following steps. A processor of the screen brightness adjustment device may be configured to obtain a screen angle. An ambient light sensor (ALS) of the screen brightness adjustment device may be configured to obtain an environmental brightness value. Then, the processor may be configured to obtain a compensation parameter according to the screen angle. Then, the processor may be configured to obtain a real environmental brightness value according to the environmental brightness value and the compensation parameter. Then, the processor may be configured to adjust a brightness of a display device of the screen brightness adjustment device according to the real environmental brightness value.

### CROSS REFERENCE TO RELATED APPLICATIONS

This application claims priority of TW Patent Application No. 113146253 filed on Nov. 29, 2024, the entirety of which is incorporated by reference herein.

### BACKGROUND OF THE INVENTION

### Field of the Invention

The invention generally relates to screen brightness adjustment technology, and more particularly, to screen brightness adjustment technology in which a compensation parameter is used to adjust the environmental brightness value detected by the ambient light sensor (ALS).

### Description of the Related Art

In current ambient light sensor (ALS) technology, the brightness value of the ALS is only adjusted when the angle between the ALS and the light source is 180°. However, in normal usage scenarios, when the angle between the ALS and the light is not 180°, errors in the environmental brightness value detected by the ALS may be generated because of the real angle of the incident light. Therefore, the environmental brightness value detected by the ALS may be different from the real environmental brightness value. As a result, the adjustment of the backlight of the screen may not correspond to the real environmental brightness value. User experience may be affected.

Therefore, how to compensate for the environmental brightness value generated by the ALS to accurately adjust the brightness of the screen is a subject that is worthy of discussion.

### BRIEF SUMMARY OF THE INVENTION

A screen brightness adjustment method and device are provided to overcome the problems mentioned above.

An embodiment of the invention provides a screen brightness adjustment method. The screen brightness adjustment method may be applied to a screen brightness adjustment device. The screen brightness adjustment method may include the following steps. A processor of the screen brightness adjustment device may be configured to obtain a screen angle. An ambient light sensor (ALS) of the screen brightness adjustment device may be configured to obtain an environmental brightness value. Then, the processor may be configured to obtain a compensation parameter according to the screen angle. Then, the processor may be configured to obtain a real environmental brightness value according to the environmental brightness value and the compensation parameter. Then, the processor may be configured to adjust a brightness of a display device of the screen brightness adjustment device according to the real environmental brightness value.

An embodiment of the invention provides a screen brightness adjustment device. The screen brightness adjustment device may comprise a display device, an ambient light sensor (ALS), and a processor. The ALS may obtain an environmental brightness value. The processor may be coupled to the display device and the ALS. The processor may obtain a screen angle. The processor may also obtain a compensation parameter according to the screen angle. The processor may also obtain a real environmental brightness value according to the environmental brightness value and the compensation parameter. The processor may further adjust a brightness of the display device according to the real environmental brightness value.

Other aspects and features of the invention will become apparent to those with ordinary skill in the art upon review of the following descriptions of specific embodiments of a screen brightness adjustment method and device.

### BRIEF DESCRIPTION OF THE DRAWINGS

The invention will become more fully understood by referring to the following detailed description with reference to the accompanying drawings, wherein:

FIG. 1 is a block diagram of a screen brightness adjustment device 100 according to an embodiment of the invention;

FIG. 2 is a flow chart illustrating a screen brightness adjustment according to an embodiment of the invention;

FIG. 3 is a schematic diagram of a vertical feature points of the face according to an embodiment of the invention;

FIG. 4 is a schematic diagram of a face angle according to an embodiment of the invention;

FIG. 5 is a schematic diagram of an enlargement ratio according to an embodiment of the invention;

FIG. 6 is a schematic diagram of obtaining the face angle according to the partial features of the face image according to an embodiment of the invention; and

FIG. 7 is a flow chart illustrating a screen brightness adjustment method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

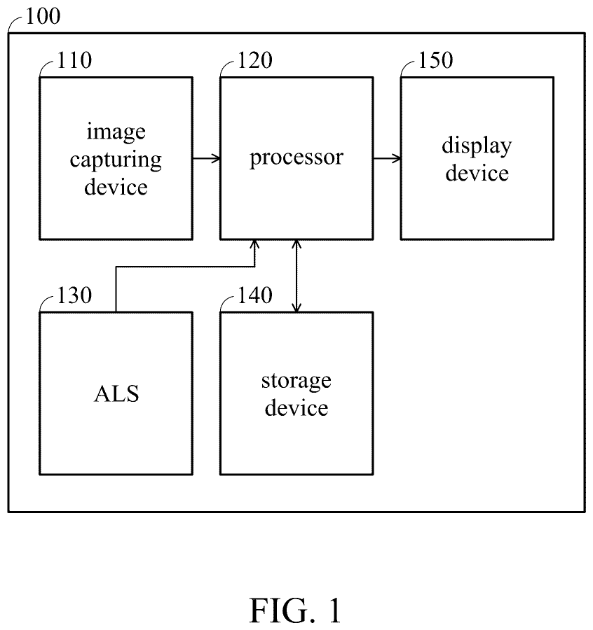

FIG. 1 is a block diagram of a screen brightness adjustment device 100 according to an embodiment of the invention. As shown in FIG. 1, the screen brightness adjustment device 100 may comprise an image capturing device 110, a processor 120, an ambient light sensor (ALS) 130, a storage device 140 and a display device 150. It should be noted that FIG. 1 presents a simplified block diagram in which only the elements relevant to the invention are shown. However, the invention should not be limited to what is shown in FIG. 1. The screen brightness adjustment device 100 may also comprise other elements.

According to an embodiment of the invention, the screen brightness adjustment device may be a smart phone, a tablet or a desk computer, but the invention should not be limited thereto.

According to an embodiment of the invention, the image capturing device 110 may be an electronic device with the photography function, e.g., a camera. The image capturing device 110 may be used to obtain the face image of the user.

According to an embodiment of the invention, the processor 120 may be a general-purpose processor, a Central Processing Unit (CPU), a Micro Control Unit (MCU), an application processor (AP), a Digital Signal Processor (DSP), a Graphics Processing Unit (GPU), a Holographic Processing Unit (HPU), a Neural Processing Unit (NPU), or the like, which includes various circuits for providing the functions of data processing and computing, storing and retrieving data (e.g., program code) to and from the storage device 140, and sending a series of frame data (e.g. representing text messages, graphics, images, etc.) to the display device 150. The processor 120 may coordinate the operations of the image capturing device 110, the ALS 130, the storage device 140, the display device 150 for performing the method of the present application.

According to an embodiment of the invention, the ALS 130 may be configured to sense (or detect) the brightness of current environment to adjust the brightness of the display device 150. According to the embodiment of the invention, the environmental brightness value detected by the ALS 130 may be compensated with a compensation parameter to increase the accuracy of the environmental brightness value detected by the ALS 130. Details will be illustrated below.

According to an embodiment of the invention, the storage device 140 may store the software and firmware program codes, system data, user data, etc. of the screen brightness adjustment device 100. The storage device 140 may be a volatile memory (e.g. Random Access Memory (RAM)), or a non-volatile memory (e.g. flash memory, Read Only Memory (ROM)), a hard disk, or a combination of the above memory devices. According to an embodiment of the invention, the storage device 140 may store the default brightness values detected by the ALS 130 in different screen angles. According to an embodiment of the invention, the default brightness values may be stored in a table form (e.g., Table 1, but the invention should not be limited thereto).

TABLE 1

| Screen angle | default brightness values detected by the ALS |
|---|---|
| 80° | 140 |
| 100° | 300 |
| 110° | 430 |
| 120° | 640 |
| 180° | 1000 |

According to an embodiment of the invention, the display device may be a Liquid-Crystal Display (LCD), a Light-Emitting Diode (LED) display, an Organic LED (OLED) display, or an Electronic Paper Display (EPD), etc., for providing a display function.

According to an embodiment of the invention, a I/O device (not shown in figures) of the screen brightness adjustment device 100 may include one or more buttons, a keyboard, a mouse, a touch pad, a microphone, and/or a speaker, etc., to serve as the Man-Machine Interface (MMI) for interaction with users.

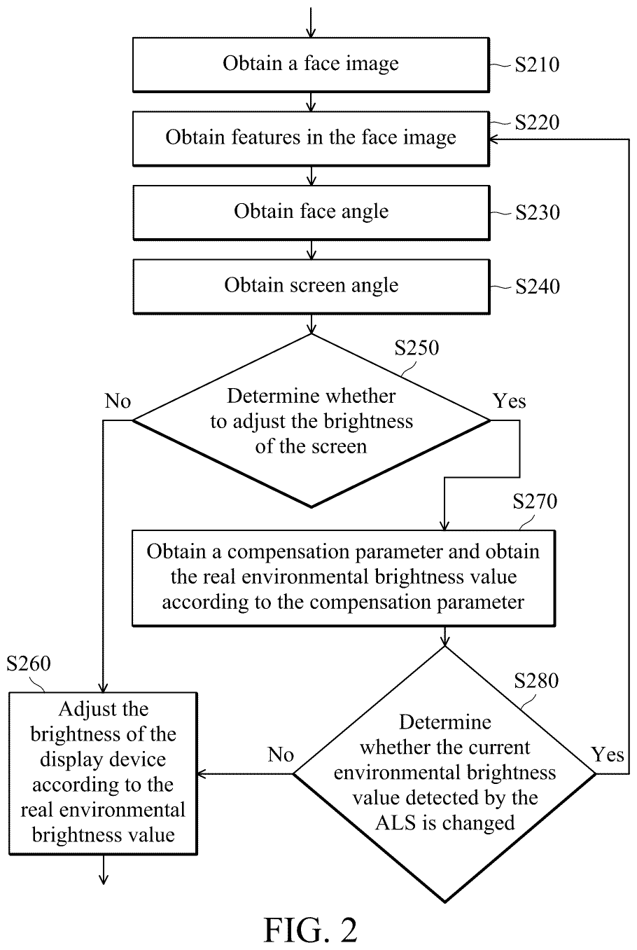

FIG. 2 is a flow chart illustrating a screen brightness adjustment according to an embodiment of the invention. The screen brightness adjustment shown in FIG. 2 can be applied to the screen brightness adjustment device 100. As shown in FIG. 2, in step S210, when the user uses the screen brightness adjustment device 100, the screen brightness adjustment device 100 may capture a face image of the user through the image capturing device 110.

In step S220, the screen brightness adjustment device 100 may obtain the features in the face image according to a facial recognition algorithm. In step S230, the screen brightness adjustment device 100 may obtain a face angle (i.e., θ_{head} shown in FIG. 4) according to the features in the face image. In step S240, the screen brightness adjustment device 100 may calculate the screen angle (i.e., the tilt angle of the display device 150) according to the obtained face angle.

For example, according to an embodiment of the invention, the screen brightness adjustment device 100 may detect the features in the face image according to a facial recognition algorithm to obtain the coordinates e_{L}(x₁, y₁) corresponding to left eye center and the coordinate e_{R}(x₂, y₂) corresponding to left eye center. When the head of the user us not rotated, the y-axis coordinates of the left eye center and the left eye center may be the same (i.e., y₂=y₁). When y₂≠y₁, it means that the head of the user is rotated around the z-axis. The rotation angle of the head (i.e., the angle of the Roll-axis) can be expressed by the formular below.

$$θ = {tan}^{- 1} ( \frac{{y}_{2} - {y}_{1}}{{x}_{2} - {x}_{1}} )$$

Before calculating the rotation ratio of the Pitch-axis, the screen brightness adjustment device 100 can calibrate the angle of the head according to the angle θ of the Roll-axis. Specifically, the screen brightness adjustment device 100 may subtract θ from the Roll-axis corresponding to each feature point, and obtain a rotation matrix R(θ). The rotation matrix R(θ) can be expressed by the formular below.

$$R ( θ ) = [ \begin{matrix}cos θ & - sin θ \\ sin θ & cos θ\end{matrix} ]$$

Then, the screen brightness adjustment device 100 may obtain the calibrated coordinates (x′, y′) according to the original coordinates (x, y) and the rotation matrix R(θ). The calibrated coordinates (x′, y′) can be expressed by the formular below.

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ]$$

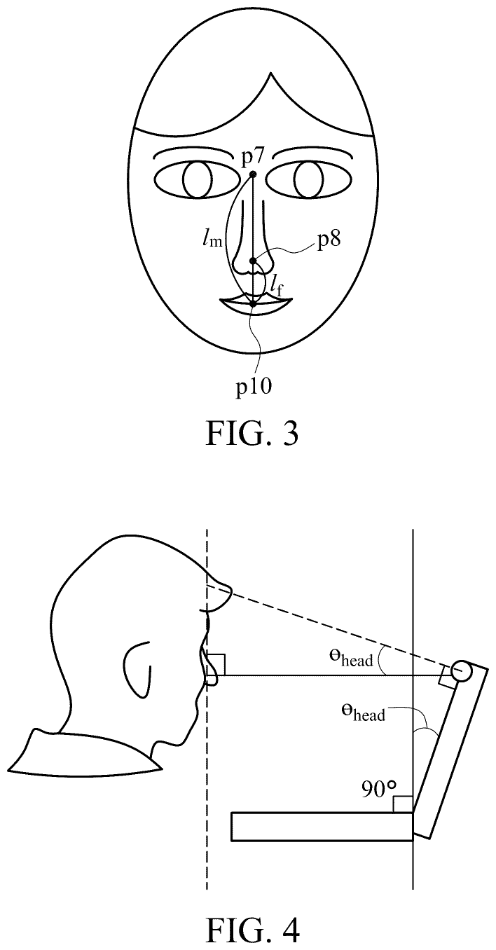

Then, the screen brightness adjustment device 100 may calculate the rotation ratio of the Pitch-axis according to the calibrated coordinates (x′, y′). FIG. 3 is a schematic diagram of a vertical feature points of the face according to an embodiment of the invention. As shown in FIG. 3, the screen brightness adjustment device 100 may select the vertical feature points, the nasal root p7 (the coordinates after the Roll-axis calibration is (x7, y7)), the nasal tip p8 (the coordinates after the Roll-axis calibration is (x8, y8)), and the center of lips p10 (the coordinates after the Roll-axis calibration is (x10, y10)), and calculate the rotation ratio of the Pitch-axis according to the coordinates of the nasal root p7, the nasal tip p8 and the center of lips p10. The rotation ratio of the Pitch-axis can be expressed by the formular below.

$$\frac{{l}_{f}}{{l}_{m}} = \frac{{y}_{8} - {y}_{10}}{{y}_{7} - {y}_{10}} ,$$

where l_{f} means the distance between the nasal tip p8 and the center of lips p10, and lₘ means the distance between the nasal root p7 and the center of lips p10. After obtaining the rotation ratio of the Pitch-axis, the screen brightness adjustment device 100 may obtain the face angle θ_{head} according to the rotation ratio of the Pitch-axis.

FIG. 4 is a schematic diagram of a face angle θ_{head} according to an embodiment of the invention. As shown in FIG. 4, the screen brightness adjustment device 100 may calculate the screen angle (i.e., the tilt angle of the display device 150) according to the face angle. Specifically, the screen angle θ_{screen} may be the face angle θ_{head} plus 90° (i.e., θ_{screen}=θ_{head}+90°).

In step S250, the screen brightness adjustment device 100 may determine whether to adjust the brightness of the screen (i.e., determine whether to compensate the environmental brightness value detected by the ALS 130) according to the screen angle θ_{screen}. When the screen brightness adjustment device 100 determines that the brightness of the screes does not need to be adjusted (i.e., the environmental brightness value detected by the ALS 130 has been the real environmental brightness value), step S260 is performed. In step S260, the screen brightness adjustment device 100 may adjust the brightness of the display device 150 according to the real environmental brightness value.

When the screen brightness adjustment device 100 determines that the brightness of the screes needs to be adjusted, step S270 is performed. In step S270, the screen brightness adjustment device 100 may obtain a compensation parameter Weight_{angle} according to the screen angle θ_{screen}, and obtain the real environmental brightness value according to the compensation parameter Weight_{angle}. Specifically, the screen brightness adjustment device 100 may look up the default brightness values detected by the ALS 130 in different screen angles (e.g., the default brightness values shown in Table 1, but the invention should not be limited thereto) according to the screen angle θ_{screen} to find the default brightness value corresponding to the screen angle θ_{screen}. Then, the screen brightness adjustment device 100 may calculate the compensation parameter Weight_{angle} according to the default brightness value corresponding to the screen angle θ_{screen}. Taking Table 1 as an example, if the screen angle θ_{screen} obtained by the screen brightness adjustment device 100 is 100°, according to the Table 1, the screen brightness adjustment device 100 may know that when the screen angle θ_{screen} is 100°, the default brightness value corresponding to the ALS 130 is 300 lux. In addition, according to the Table 1, the screen brightness adjustment device 100 may know that when the screen angle θ_{screen} is 180°, the default brightness value corresponding to the ALS 130 is 1000 lux. Therefore, according to the obtained information, the screen brightness adjustment device 100 may calculate the compensation parameter Weight_{100°} when the screen angle θ_{screen} is 100°. The compensation parameter Weight_{100°} can be expressed by the formular below.

$${Weight}_{100 °} = \frac{{Lux}_{180 °}}{{Lux}_{100 °}} = \frac{1000}{300} ≅ 3.33$$

Then, the screen brightness adjustment device 100 may compensate the current environmental brightness value (i.e., Lux_{ALS}) detected by the ALS 130 according to the compensation parameter (i.e., Weight_{angle}) to obtain the real environmental brightness value (i.e., Lux_{Real}). According to an embodiment of the invention, the screen brightness adjustment device 100 may multiply the current environmental brightness value (i.e., Lux_{ALS}) by the compensation parameter (i.e., Weight_{angle}) to obtain the real environmental brightness value (i.e., Lux_{Real}). For example, if the screen angle θ_{screen} is 100°, the current environmental brightness value Lux_{ALS} detected by the ALS 130 is 400 lux, and the compensation parameter Weight_{angle} corresponding to the screen angle θ_{screen} 100° is 3.33, the screen brightness adjustment device 100 may multiply the current environmental brightness value Lux_{ALS} by the compensation parameter Weight_{angle} to obtain the real environmental brightness value Lux_{Real} (i.e., 400×3.33=1332 lux).

In step S280, the screen brightness adjustment device 100 may determine whether the current environmental brightness value detected by the ALS 130 is varied or changed. If the current environmental brightness value detected by the ALS 130 is changed and the changed value exceeds a threshold, the screen brightness adjustment device 100 may calculate the screen angle again (i.e., perform steps S220˜S280 again). If the current environmental brightness value detected by the ALS 130 is not changed or the changed value does not exceed the threshold, the screen brightness adjustment device 100 may perform step S260. That is, the screen brightness adjustment device 100 may adjust the brightness of the display device 150 according to the real environmental brightness value.

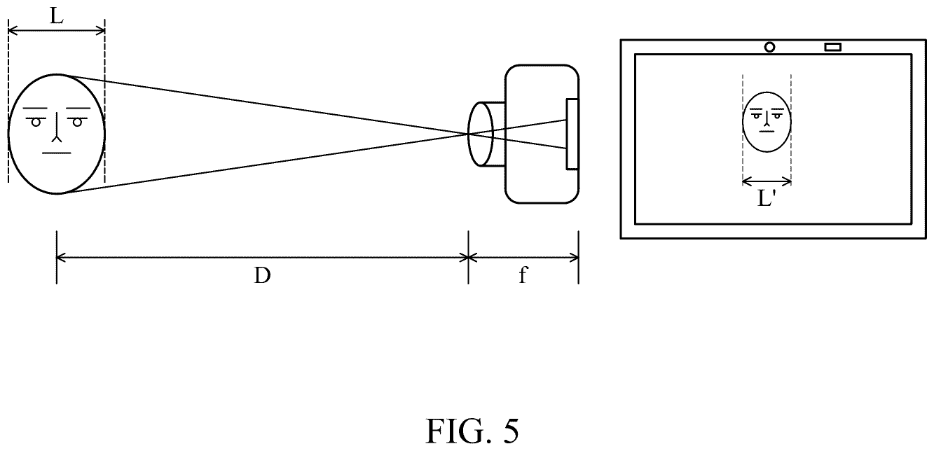

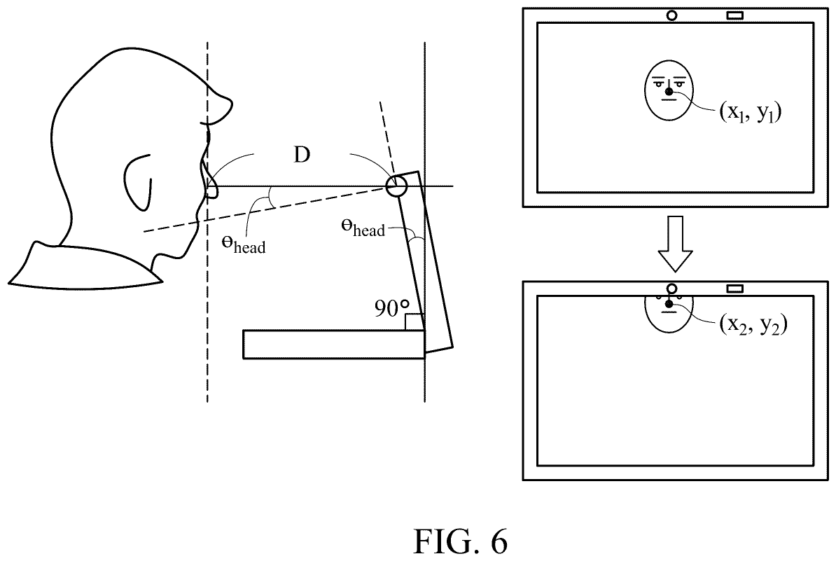

According to an embodiment of the invention, when the screen brightness adjustment device 100 cannot obtain the features of the complete face (e.g., the face image generated the image capturing device 110 may only comprise partial face of the user), the screen brightness adjustment device 100 may obtain the screen angle θ_{screen} according to the coordinate information and the enlargement ratio corresponding to the partial features of the face image. For example, when the screen angle θ_{screen} is smaller than 90°, the face image generated the image capturing device 110 may only comprise lip feature point of the user. Therefore, the screen brightness adjustment device 100 may obtain the screen angle θ_{screen} according to the coordinate information and the enlargement ratio corresponding to the lip feature point. Details for the embodiment will be illustrated by referring to FIG. 5 and FIG. 6 below.

FIG. 5 is a schematic diagram of an enlargement ratio according to an embodiment of the invention. As shown in FIG. 5, it is assumed that the focal length f of the image capturing device 110 is 1 millimeter (mm), and the width L′ of the complete face of the user in the face image is 0.028 cm. In addition, the average face width L is defined by averaging the average face width of the oriental man (e.g., 14.5 cm) and the average face width of the oriental woman (e.g., 13.6 cm), i.e., L=(14.5+13.6)/2≅14 cm. The screen brightness adjustment device 100 may substitute the f=1 mm, L=14 cm, and L′=0.028 cm into a formular to obtain the distance D between the user and the image capturing device 110. Specifically, the screen brightness adjustment device 100 may calculate the distance D between the user and the image capturing device 110 according to the formular below (i.e., D=((0.1)×14)/0.028=50 cm).

$$D = \frac{f \times L}{{L}^{′}}$$

According to the above formular, the screen brightness adjustment device 100 may know that the distance D between the user and the image capturing device 110 is 50 cm. Then, the screen brightness adjustment device 100 may obtain the enlargement ratio M according to the average face width L and the width L′ of the complete face of the user in the face image. The calculation of the enlargement ratio M can be expressed by the formular below.

$$M = \frac{L}{{L}^{′}} = \frac{14}{0.028} = 500$$

FIG. 6 is a schematic diagram of obtaining the face angle according to the partial features of the face image according to an embodiment of the invention. As shown in FIG. 6, when the screen angle θ_{screen} is smaller than 90°, the face image generated the image capturing device 110 may only comprise lip feature point of the user. Therefore, the image capturing device 110 may calculate the shift distance (i.e., L′_{Mouth}) of the coordinates of the lip feature point from the face image comprising complete face to face image comprising partial face (i.e., the screen angle θ_{screen} is changed from the angel not smaller than 90° to the angle smaller than) 90° according to the formular below.

$${L}_{Mouth}^{′} = \sqrt{{( {x}_{2} - {x}_{1} )}^{2} + {( {y}_{2} - {y}_{1} )}^{2}}$$

As shown in FIG. 6, if the coordinates of the lip feature point corresponding to the face image comprising complete face is (x1, y1)=(0, 0), and the coordinates of the lip feature point corresponding to the face image comprising partial face is (x2, y2)=(0, 0.018), the screen brightness adjustment device 100 may obtain the shift distance L′_{Mouth} is 0.018 cm.

Then, the screen brightness adjustment device 100 may multiply the shift distance L′_{Mouth} by the enlargement ratio M to obtain the real shift distance L_{Mouth} of the lips of the user (i.e., L_{Mouth}=M×L′_{Mouth}=9 cm). Then, the screen brightness adjustment device 100 may substitute the real shift distance L_{Mouth}, and the known distance D (as shown inn FIG. 5) between the user and the image capturing device 110 into the formular below to obtain the face angle θ_{head}.

$${θ}_{head} = {tan}^{- 1} ( \frac{{L}_{Mouth}}{D} ) ≅ 10 °$$

In the embodiment of FIG. 6, the screen brightness adjustment device 100 may further determine that the face angle θ_{head} is positive value or negative value. For example, if the face image only comprises the eye feature points, the screen brightness adjustment device 100 may determine that the face angle θ_{head} is positive value. If the face image only comprises the lips features, the screen brightness adjustment device 100 may determine that the face angle θ_{head} is negative value. Therefore, in the embodiment of FIG. 6, the screen brightness adjustment device 100 may determine that the face angle θ_{head} is negative value. Therefore, after the calculation of the formular below, the screen brightness adjustment device 100 may obtain the screen angle θ_{screen}.

$${θ}_{screen} = 90 ° + {θ}_{head} = 90 ° + ( - 10 ° ) = 80 °$$

For similar operations of FIG. 2, after the screen brightness adjustment device 100 obtains the screen angle θ_{screen}, the screen brightness adjustment device 100 may perform the operations of step S250˜S280 to determine whether adjust the brightness of the display device 150.

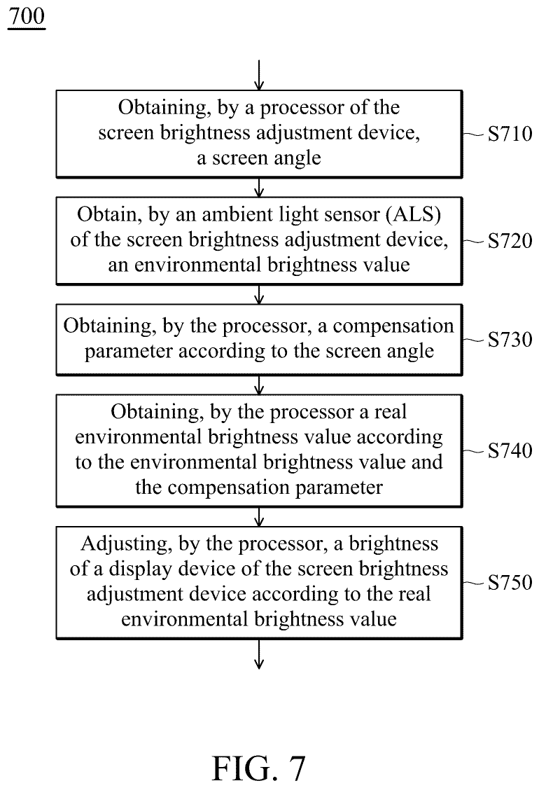

FIG. 7 is a flow chart 700 illustrating a screen brightness adjustment method according to an embodiment of the invention. The screen brightness adjustment method can be applied to the screen brightness adjustment device 100. As shown in FIG. 7 in step S710, a processor of the screen brightness adjustment device 100 may obtain a screen angle.

In step S720, an ALS of the screen brightness adjustment device 100 may obtain an environmental brightness value.

In step S730, the processor of the screen brightness adjustment device 100 may obtain a compensation parameter according to the screen angle.

In step S740, the processor of the screen brightness adjustment device 100 may obtain a real environmental brightness value according to the environmental brightness value and the compensation parameter.

In step S750, the processor of the screen brightness adjustment device 100 may adjust the brightness of a display device of the screen brightness adjustment device 100 according to the real environmental brightness value.

According to an embodiment of the invention, in the screen brightness adjustment method, an image capturing device of the screen brightness adjustment device 100 may obtain a face image.

According to an embodiment of the invention, in the screen brightness adjustment method, the screen brightness adjustment device 100 may obtain the screen angle according to the face image.

According to an embodiment of the invention, in the screen brightness adjustment method, the processor of the screen brightness adjustment device 100 may obtain the features of the face image according to a facial recognition algorithm. Then, the processor of the screen brightness adjustment device 100 may obtain a face angle according to the features of the face image. Then, the processor of the screen brightness adjustment device 100 may calculate the screen angle according to the face angle.

According to an embodiment of the invention, in the screen brightness adjustment method, when the features of complete face are not obtained in the face image (i.e., the face image does not comprise complete face), the processor of the screen brightness adjustment device 100 may obtain a face angle according to the coordinate information corresponding to the partial features of the face image and a known distance between the user and the image capturing device, and obtain the screen angle according to the face angle. According to an embodiment of the invention, in the screen brightness adjustment method, when the face image only comprises the lip feature point, the face angle may be a negative value. According to an embodiment of the invention, in the screen brightness adjustment method, when the face image only comprises the eye feature points, the face angle may be a positive value.

According to an embodiment of the invention, in the screen brightness adjustment method, a storage device of the screen brightness adjustment device 100 may pre-store the default brightness values corresponding to the ALS for different screen angles. In addition, the processor of the screen brightness adjustment device 100 may obtain the compensation parameter according to the screen angle and the default brightness value corresponding to the screen angle.

According to an embodiment of the invention, in the screen brightness adjustment method, the processor of the screen brightness adjustment device 100 may determine whether a change value of the environmental brightness value obtained by the ALS exceeds a threshold. When the change value exceeds the threshold, the processor of the screen brightness adjustment device 100 may calculate the screen angle again.

According to an embodiment of the invention, in the screen brightness adjustment method, the processor of the screen brightness adjustment device 100 may obtain the real environmental brightness value by multiplying the environmental brightness value by the compensation parameter.

According to the screen brightness adjustment method provided in the invention, the environmental brightness value obtained by the ALS can be compensated by generating the compensation parameter, and then the brightness of the screen can be adjusted according to the compensated environmental brightness value. Therefore, according to the screen brightness adjustment method provided in the invention, the accuracy of the ALS can be increased. In addition, the display effect can be increased to achieve better user experience.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A screen brightness adjustment method, applied to a screen brightness adjustment device, comprising:
obtaining, by a processor of the screen brightness adjustment device, a screen angle;
obtain, by an ambient light sensor. (ALS) of the screen brightness adjustment device, an environmental brightness value;
obtaining, by the processor, a compensation parameter according to the screen angle;
obtaining, by the processor, a real environmental brightness value according to the environmental brightness value and the compensation parameter; and
adjusting, by the processor, a brightness of a display device of the screen brightness adjustment device according to the real environmental brightness value.

2. The screen brightness adjustment method of claim 1, further comprising:
obtaining, by an image capturing device of the screen brightness adjustment device, a face image.

3. The screen brightness adjustment method of claim 2, further comprising:
obtaining, by the processor, the screen angle according to the face image.

4. The screen brightness adjustment method of claim 3, wherein the obtaining the screen angle according to the face image further comprises:
obtaining, by the processor, features of the face image according to a facial recognition algorithm;
obtaining, by the processor, a face angle according to the features of the face image; and
calculating, by the processor, the screen angle according to the face angle.

5. The screen brightness adjustment method of claim 1, further comprising:
when the features of a complete face are not obtained in the face image, obtaining, by the processor, a face angle according to coordinate information corresponding to partial features of the face image and a known distance between a user and an image capturing device; and
obtaining, by the processor, the screen angle according to the face angle.

6. The screen brightness adjustment method of claim 5, wherein when the face image only comprises a lip feature point, the face angle is a negative value.

7. The screen brightness adjustment method of claim 5, wherein when the face image only comprises eye feature points, the face angle is a positive value.

8. The screen brightness adjustment method of claim 1, further comprising:
pre-storing, by a storage device of the screen brightness adjustment device, default brightness values corresponding to the ALS for different screen angles; and
obtaining, by the processor, the compensation parameter according to the screen angle and the default brightness value corresponding to the screen angle.

9. The screen brightness adjustment method of claim 1, further comprising:
determining, by the processor, whether a change value of the environmental brightness value obtained by the ALS exceeds a threshold; and
when the change value exceeds the threshold, calculating, by the processor, the screen angle again.

10. The screen brightness adjustment method of claim 1, further comprising:
obtaining, by the processor, the real environmental brightness value by multiplying the environmental brightness value by the compensation parameter.

11. A screen brightness adjustment device, comprising:
a display device;
an ambient light sensor. (ALS), obtaining an environmental brightness value; and
a processor, coupled to the display device and the ALS,
wherein the processor obtains a screen angle, obtains a compensation parameter according to the screen angle, obtains a real environmental brightness value according to the environmental brightness value and the compensation parameter, and adjusts a brightness of the display device according to the real environmental brightness value.

12. The screen brightness adjustment device of claim 11, further comprising:
an image capturing device, coupled to the processor and configured to obtain a face image.

13. The screen brightness adjustment device of claim 12, wherein the processor obtains the screen angle according to the face image.

14. The screen brightness adjustment device of claim 13, wherein the processor obtains features of the face image according to a facial recognition algorithm, obtains a face angle according to the features of the face image, and calculates the screen angle according to the face angle.

15. The screen brightness adjustment device of claim 11, wherein when the features of a complete face are not obtained in the face image, the processor obtains a face angle according to coordinate information corresponding to partial features of the face image and a known distance between a user and an image capturing device, and obtains the screen angle according to the face angle.

16. The screen brightness adjustment device of claim 15, wherein when the face image only comprises a lip feature point, the face angle is a negative value.

17. The screen brightness adjustment device of claim 15, wherein when the face image only comprises eye feature points, the face angle is a positive value.

18. The screen brightness adjustment device of claim 11, further comprising:
a storage device, pre-storing default brightness values corresponding to the ALS for different screen angles,
wherein the processor obtains the compensation parameter according to the screen angle and the default brightness value corresponding to the screen angle.

19. The screen brightness adjustment device of claim 11, wherein the processor determines whether a change value of the environmental brightness value obtained by the ALS exceeds a threshold, and when the change value exceeds the threshold, the processor calculates the screen angle again.

20. The screen brightness adjustment device of claim 11, wherein the processor obtains the real environmental brightness value by multiplying the environmental brightness value by the compensation parameter.
